(19) United States
(12) Patent Application Publication
(10) Pub. No.: US 2019/0076224 A1
(43) Pub. Date: Mar. 14, 2019

(54) DENTAL FLOSS AND METHODS FOR USING AND MANUFACTURING THE SAME

(71) Applicant: Quip NYC Inc., New York, NY (US)

(72) Inventors: William Thomas May, Summit, NJ (US); Simon Enever, New York, NY (US)

(21) Appl. No.: 16/128,065

(22) Filed: Sep. 11, 2018

Related U.S. Application Data
(60) Provisional application No. 62/557,499, filed on Sep. 12, 2017.

(51) Int. Cl. A61C 15/04

(52) U.S. Cl. CPC A61C 15/041; A61C 15/046

(57) ABSTRACT

Dental floss provided in the form of a continuous loop includes at least one tab positioned on the loop. The at least one tab provides a gripping feature for the continuous loop of floss material. A separate pick device can be configured to receive the continuous loop of floss material with the at least one tab positioned thereon. A cutout portion of the pick device provides the usable area for the floss once positioned in the holder. The pick device is configured to receive the continuous loop of dental floss material to assist in the use of the dental.

### CROSS REFERENCE TO RELATED APPLICATIONS

This application claims priority from U.S. Provisional Application Ser. No. 62/557,499 filed on Sep. 12, 2018.

### BACKGROUND

### Technical Field

The present principles relate to dental floss. More particularly, they relate to the design and manufacturing of dental floss.

### Related Art

According to the known art, dental floss comes in a string form and is generally dispensed from a bobbin contained within a dispenser housing. A cutting device is also generally provided in order allow the user to cut the single string of floss into a desired length. The user then uses the cut strand of floss by hand.

Other implementations of dental floss include the pre-fabricated picks having a short piece of floss spanning across two supports. These picks generally come in packs and are single use items. Once used, the user throws this entire pick and used floss away.

In is therefore desirable to provide a new dental floss system that makes it easier to use both by hand and with a re-usable pick device.

### SUMMARY

According to an implementation, the dental floss includes a first tab having opposing ends, and a piece of dental floss material. The piece of dental floss material has one end connected to one end of the first tab and a second end connected to an opposing end of the first tab, thereby forming a continuous loop of dental floss material.

According to another implementation, the dental floss includes a first tab and a first strand of dental floss material having one end connected to the first tab and an opposing end. A second tab is connected to the opposing end of the first strand of dental floss material. A second strand of dental floss material has one end connected to the first tab and an opposing end connected to the second tab. The first and second strands of floss material connected to the first and second tabs forms a dental floss loop.

According to other implementations, the dental floss is manufactured into loops having approximate diameter of in a range of 2.5-3 inches. With this loop, a user can hold and work the floss with their fingers in their oral cavity more easily, with greater control and with less pain and constriction against their fingers from winding.

According to yet other implementations, the loop of floss can be manufactured in various ways. In one implementation, a single piece of floss is connected at both ends by a tab that resembles a small oval like shape (similar in shape to the TIC TAC® candy) to create the loop. TIC TAC is a registered Trademark of FERRERO S.P.A.

According to another implementation, two pieces of floss can be connected at their respective ends to a tab, such that the loop has two tabs on opposing sides of the loop.

According to another implementation, the dental floss loop having two tabs can have two tabs of different size, which can be used to facilitate dispensing from a dispenser unit.

According to yet another implementation, the dental floss has a split loop construction, where a wider strand of floss is split down its length so it can be opened from the middle to form a loop. The split can be a pre-cut split or a perforated split that the user separates once ready to use (or dispensed). In one implementation, the split is centrally located along the length of the floss strand. In another implementation, the split can be of center along the length of the floss so as to provide two different sizes (e.g., thick and thin) of floss for the user's selection.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a plan view of the dental floss loop according to one implementation of the present principles;

FIG. 2 is a plan view of the dental floss loop according to another implementation of the present principles;

FIG. 3 is a plan view of the dental floss loop according to yet another implementation of the present principles;

FIG. 4 is a plan view of the dental floss loop according to yet another implementation of the present principles;

FIG. 5 is a plan view of the dental floss loop according a further implementation of the present principles;

FIG. 6 is a schematic view of a method for manufacturing the dental floss loop shown in the implementation of FIG. 4;

FIGS. 7A and 7B show a plan view and enlarged view, respectively, of the dental floss loop according to yet a further implementation of the present principles;

FIG. 8 is a plan view of the dental floss loop showing use of two different materials, according to yet another further implementation of the present principles;

FIGS. 9A and 9B show a plan view of the dental floss loop and method for manufacturing the same, respectively, according to a further implementation of the present principles;

FIGS. 10A and 10B show a plan view of the dental floss loop and method for manufacturing the same, respectively, according to another implementation of the present principles;

FIGS. 11A and 11B show a plan view of the dental floss loop and method for manufacturing the same, respectively, according to yet another implementation of the present principles;

FIG. 12 shows a schematic view of a method for manufacturing the dental floss loop shown in FIG. 2 or 3, according to an implementation of the present principles;

FIGS. 13 and 14 show a plan view of a series of dental floss loops of FIG. 2 and FIG. 3, respectively, which can be used for dispensing from a dispenser unit;

FIG. 15A shows a view of a dental floss pick device to be used with the dental floss loop shown in FIG. 1, according to an implementation of the present principles;

FIG. 15B shows a view of a dental floss pick device to be used with the dental floss loop shown in FIG. 2, according to an implementation of the present principles;

FIG. 15C shows a view of the dental floss pick device having a tensioning mechanism, according to an implementation of the present principles;

FIG. 16 is a plan view of a floss dispenser according to an implementation of the present principles;

FIG. 17 is a plan view of the floss dispenser according to one implementation of the present principles;

FIG. 18 is a plan view of the floss dispenser according to another implementation of the present principles;

FIG. 19 is a plan view of a rolled loop of floss according to another implementation of the present principles;

FIGS. 20A and 20B are views of the manufacturing process of the rolled loop shown in FIG. 19;

FIG. 21 is a plan view of a rolled loop manufacturing of the floss loop according to an implementation of the present principles; and

FIGS. 22A and 22B are views of the manufacturing of a wound loop according to an implementation of the present principles.

### DETAILED DESCRIPTION

The present principles are directed to dental floss and the use and manufacturing of the same.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

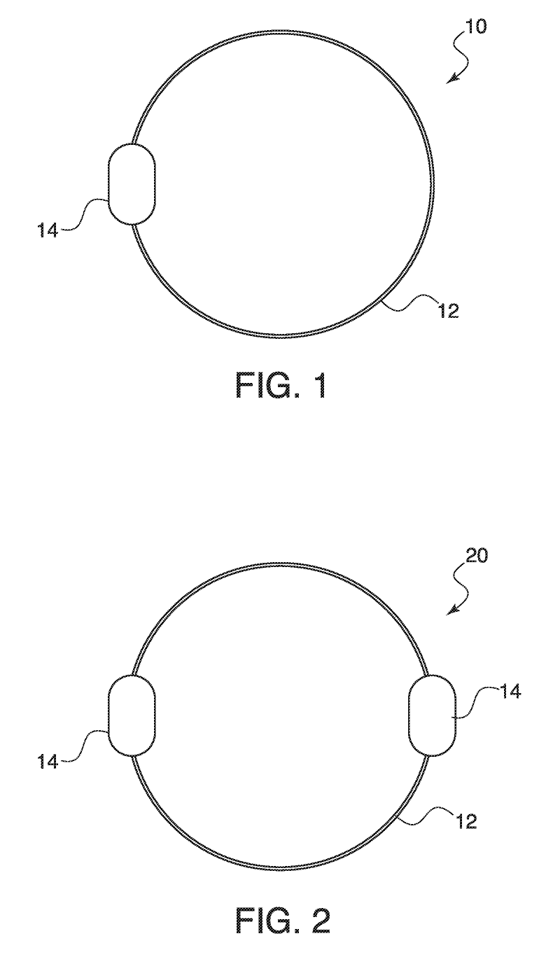

FIG. 1 shows an example of the dental floss loop 10 according to one embodiment. Here a single piece of dental floss 12 is configured in a loop and is formed using a tab 14 to connect the ends of the same. The tab 14 tab can be made of plastic and resembles a small oval like shape (similar in shape to the TIC TAC® candy) to create the loop. TIC TAC is a registered Trademark of FERRERO S.P.A. The tab 14 assists the user in holding the floss loop during use of the same. To manufacture this loop 10, the strand of floss 12 is looped in an injection mold and overmolded at the end points connecting the loop.

FIG. 2 shows another embodiment of the dental floss loop 20 according to the present principles. In this embodiment, two pieces of dental floss 12 are connected to each other by two tabs 14 to form the loop. The use of two tabs 14 in this embodiment helps the user further in providing two grabbing locations for using the floss.

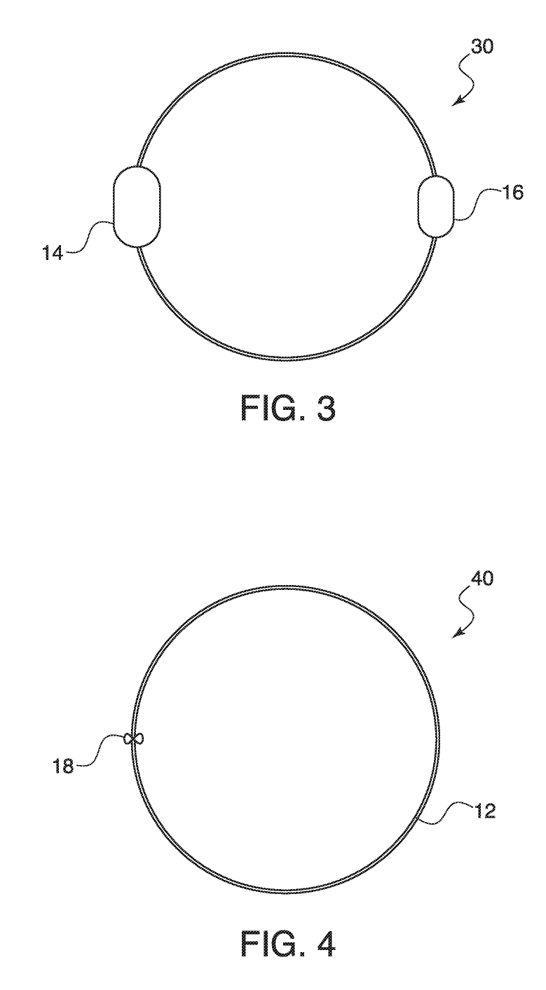

FIG. 3 shows a further embodiment of the dental floss loop 30 where the floss 12 is connected by two tabs 14 and 16, which have a different size with respect to each other. The different size tabs 14 and 16 not only provide two grabbing locations for the user, but also provide a means for dispensing and/or cutting the floss which will be described later.

The tabs 14 and 16 as described above can be made of plastic, or any other suitable known material. In some contemplated embodiments, the tabs can be made of a bio-degradable material (e.g., fibrous/paper material), or in other embodiments, can be removable to separate the materials.

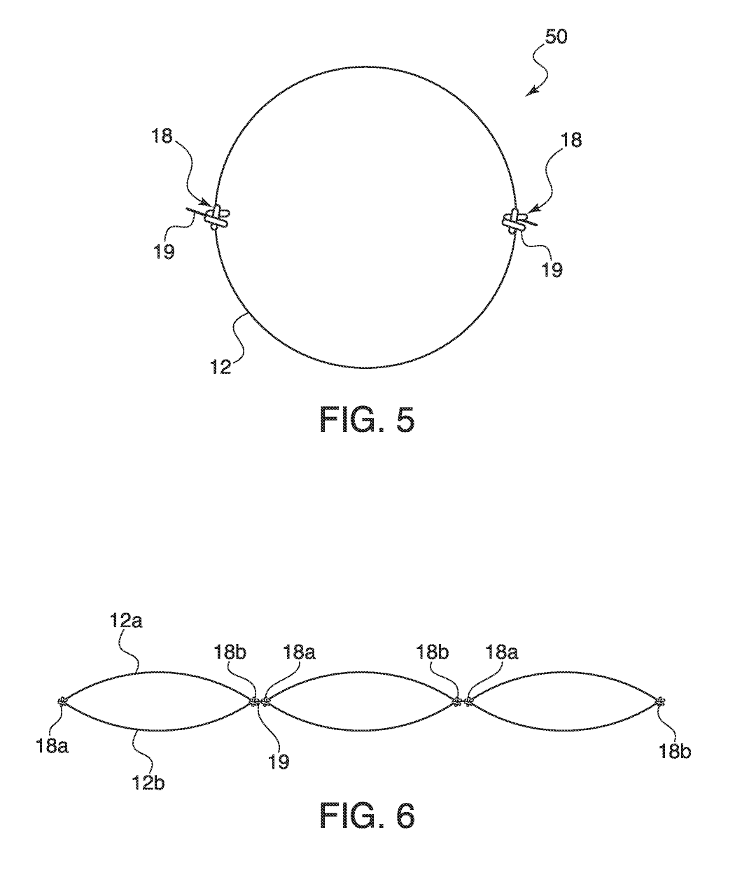

FIG. 4 shows another embodiment of the dental floss loop 40 where the loop of the floss 12 is formed by a knot 18. FIG. 5 shows another example of the dental floss loop 50 showing multiple knots 18 along the loop. The knotting can be performed by a continuous looming machine and the knots 18 formed thereby could be reinforced by heat or pressure to increase integrity. The extra portions 19 are the remainder after the breaks or cuts between floss loops is performed. In one implementation, the knots 18 could be colored to dispensing purposes or for length measurement purposes for the user. The knots 18 would be small enough to act as raised portions of the floss which would operate to improve the flossing experience. In another implementation, the knots are added to the floss material 12 of the embodiment of FIGS. 1-3. In this implementation, the knots would be spaced from the tab or tabs.

FIG. 6 shows another example of manufacturing where two strips of dental floss 12A and 12B are connected together by a knots 18A and 18B, thus forming a loop between them. The small space between knot 18B and 18C would be a cutting point where either the dispenser is configured to cut at this point, or a weaker material is used at between the knots 18B and 18C so the user could tear or break the same at that point.

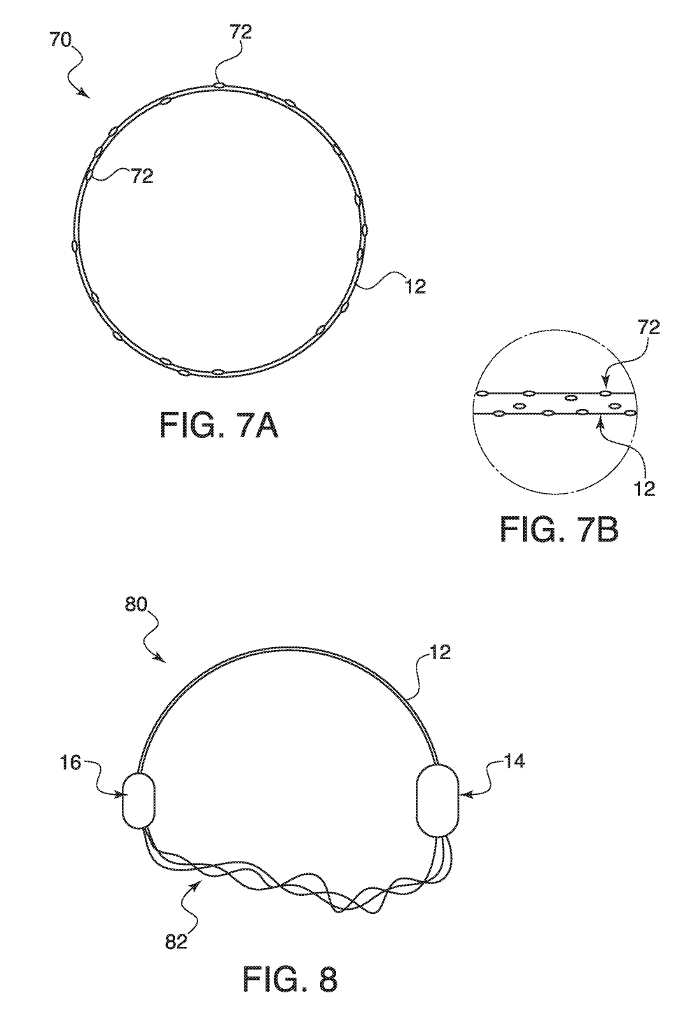

FIGS. 7A and 7B show yet another embodiment of the dental floss loop 70 according to the present principles. As shown, the dental floss 12 is wound into a looped shape and anchored with one or more dots of glue 72 along the length of the same. Here it will be appreciated that the glued dots 72 act as raised bumps to improve the flossing experience.

FIG. 8 shows an alternative embodiment of the split loop dental floss design where two different materials are used on opposing sides of the loop formed by the tabs 14 and 16. Here, the dental floss 12 makes up half the loop, and another material 82 makes up the other half of the loop. The alternative material 82 can take the form of expanding floss to reach between teeth which have larger gaps.

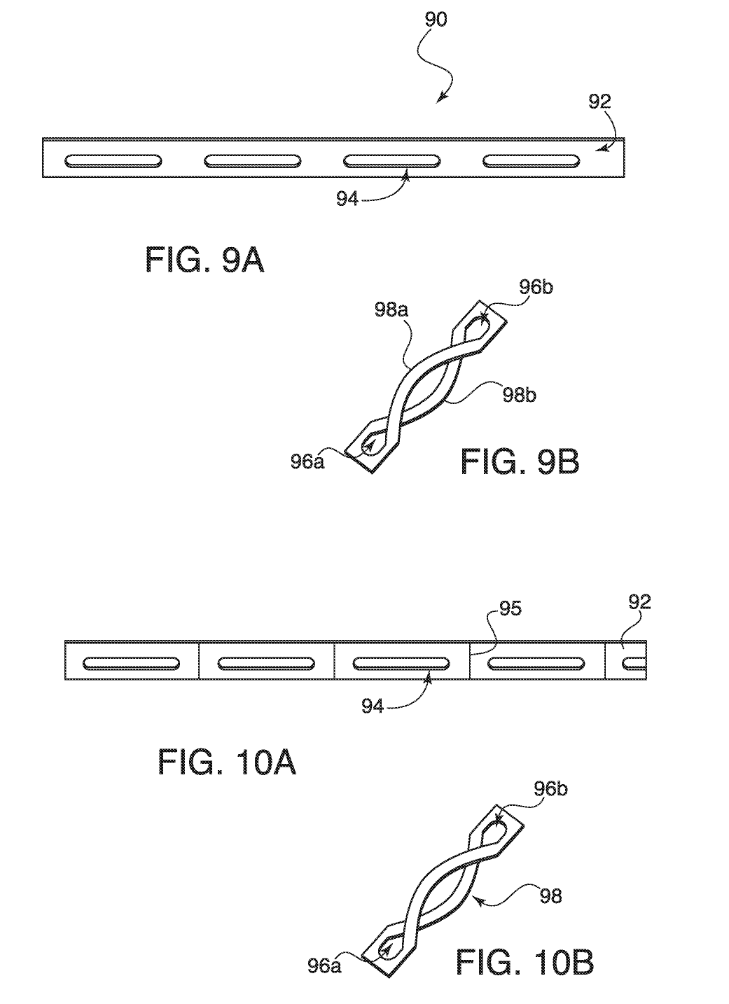

FIG. 9A shows yet another embodiment of the dental floss 90 of the present principles. Here, a wider (tape-like) strand of floss 92 is split down its length with splits 94 at spaced intervals. The splits 94 can be formed by cutting, pressing or applying heat. As shown in FIG. 9B, at predetermined intervals, the split portions become the hand gripping areas 96A and 96b while providing the two strands of floss 98A and 98B. In this embodiment, color or material indications along the length could be provided at the cutting points to assist the user in identifying the proper cut locations.

FIGS. 10A and 10B show another version of the dental floss 90 of the present principles. Here, perforated lines 95 are added between the loops 98 to aide in the easily removal of the same from the strip 92. The perforations 95 could eliminate the need for any other type of cutting line indicator for the user.

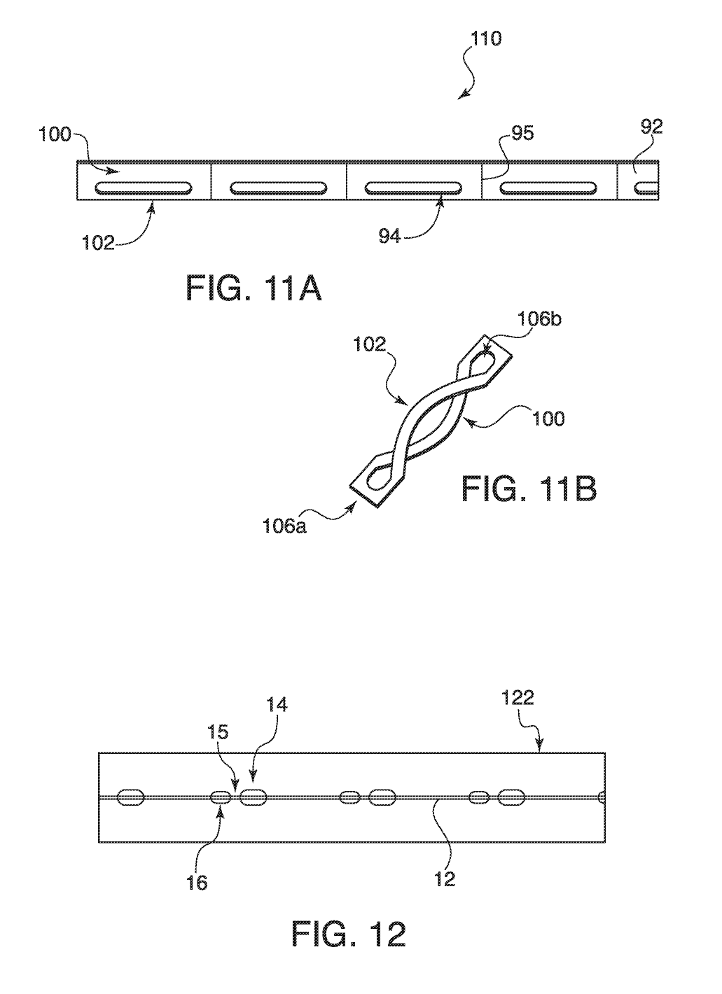

FIGS. 11A and 11B show yet another embodiment of the dental floss 110 according to the present principles. Here the splits 94 in the strip 92 are off center, thus forming different size floss stripes 100 and 102 which form the loop. The ends 106A and 106B operate as the handles or gripping areas for the loop formed in this manner.

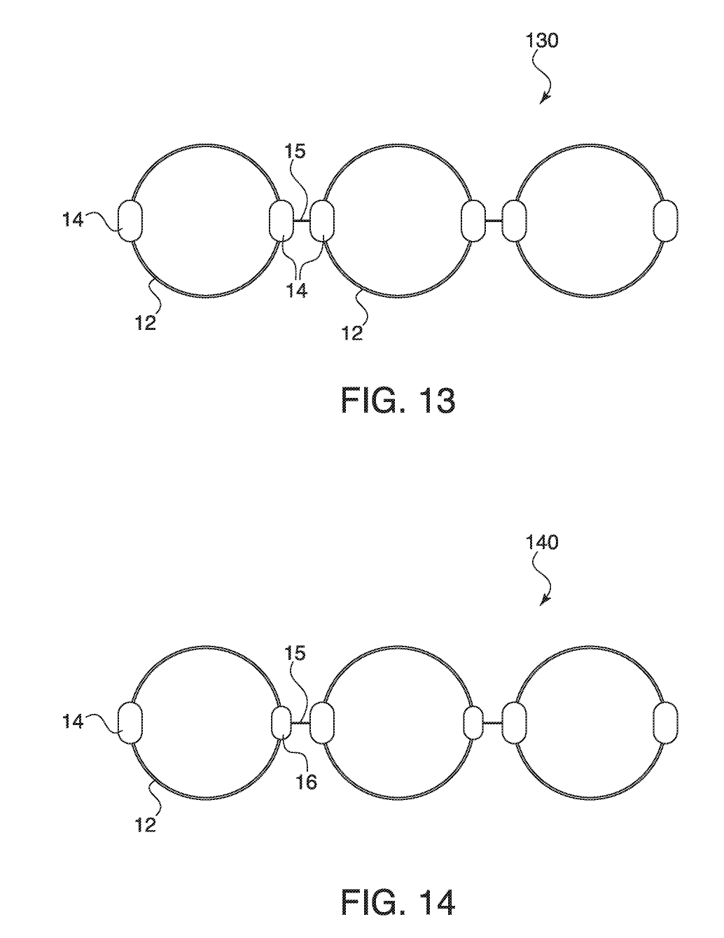

FIG. 12 shows a schematic diagram of the molding of the plastic tabs onto the floss 12. A strip or carrier 122 is provided with the floss 12 thereon. The tabs 14 and 16 are molded in position so as to provide a small spacing 15 between the closely adjacent tabs. FIG. 13 shows a plan view of this same concept where the tabs 14 are all the same size. In FIG. 14, the tabs are shown in this plan view in the different sizes 14 and 16 as described earlier.

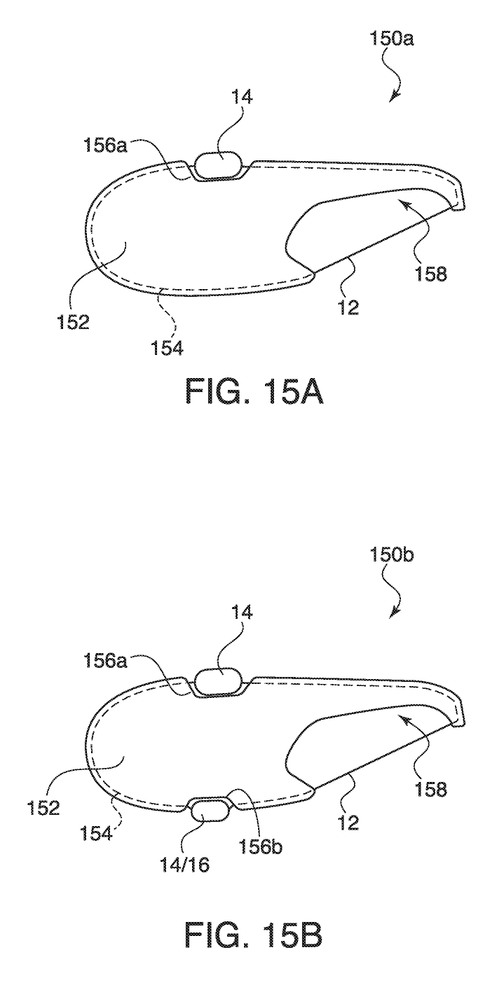

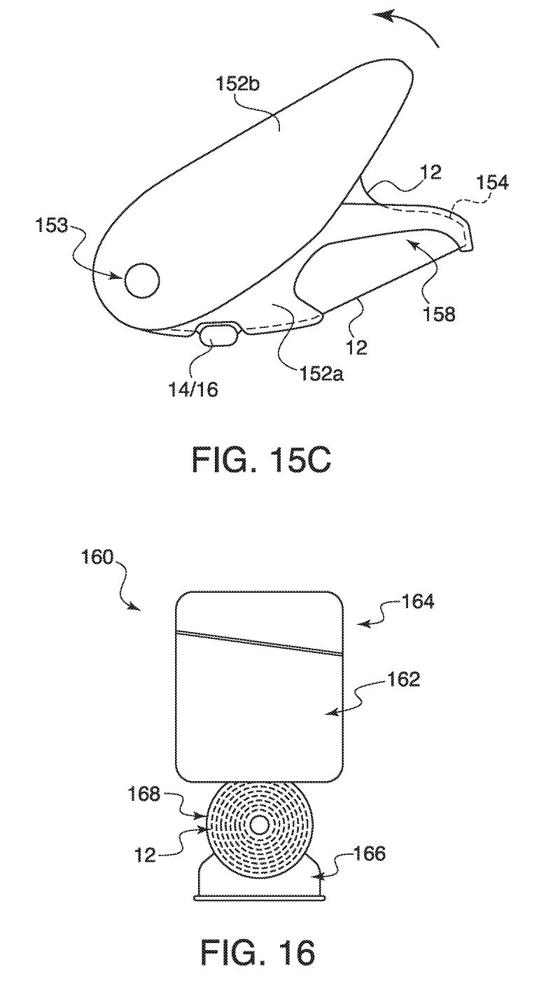

FIGS. 15A and 15B show two embodiments 150A and 150b, respectively of a pick device or dental floss holder that receives the floss loop of the present invention. The pick device 150A is configured for the single tab embodiment, and includes a housing 152 having a circumferential channel 154 around the same. An indentation 156A is provided in the path of the channel 154 and is configured to receive the tab 14. A cutout portion 158 provides the usable area for the floss once positioned in the pick. Once the tab 14 is positioned in indentation 156A, the floss loop 12 is positioned in the channel around the housing 152 such that the floss 12 spans the area created by cutout 158.

FIG. 15B shows the housing 152 having two indentations 156A and 156B to accommodate the embodiment of two tabs on the floss loop (See FIGS. 2 and 3). The size of the tabs 14/16 can be the same or different which the indentations 156A and 156B being configured accordingly. The operation is the same as that shown in FIG. 15A. In the embodiments shown in FIGS. 15A and 15B, more than one cutout portion 158 could be provided, such that the pick has multiple open sections that will allow the floss loop to be used to get in between teeth. This would also allow the user to switch floss sections for any reason (e.g., floss becomes dirty, or different section fits better in a particular oral location).

In the embodiments of FIGS. 15A and 15B, the tab 14 can be used engaged by the user during to increase tension on the floss 12. FIG. 15C shows an embodiment of the pick having a tensioning mechanism built in. Here, the housing 152 is split into two parts 152A and 152B, the former having a similar structure as that shown in embodiments of FIGS. 15A and 15B, and the latter being rotatably connected to the housing 152A via a hinge or pivot point 153. When the floss loop is positioned in the outer channel 154 of housing 152A and engaged in at least a portion of the housing 152B, when the housing 152B is rotated in the direction of Arrow A relative to the other housing part 152A, the same causes an increase in tension of the floss 12 across the opening formed by cutout 158.

FIGS. 16-18 show embodiments of a floss dispenser according to the present principles. FIG. 16 shows a dispenser 169 having a housing 162 with a cover or lid 164. A mechanism 166 is inserted into the housing 162 from the bottom and locks or snaps into place (how?) . . . . The mechanism 166 includes a roll of floss loops 12 to be dispensed as needed.

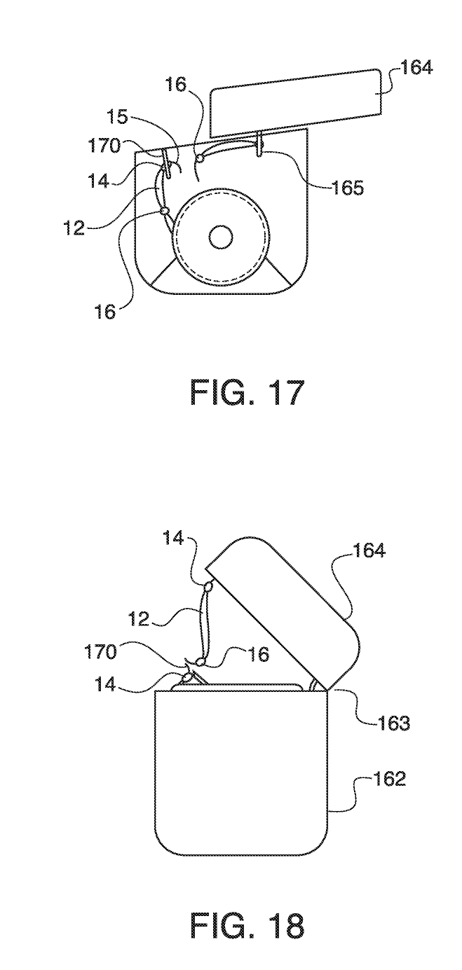

FIG. 17 shows one embodiment of floss dispensing. In this embodiment, the cap or lid 164 slides backward, and grabs the larger tab 14 using a gate 165 such that the next tab 16 (of small size passes through the cutter 170 which cuts the floss 12 at that point 15 between the adjacent dental floss loops 12 defined by the tabs 14 and 16 (See FIG. 12). When the lid 164 is returned to the closed position, the gate is configured to grab the next tab 14 and wait for the next dispensing action

FIG. 18 shows another embodiment of the floss dispensing. In this embodiment, the cap or lid 164 is hingedly connected 163 to the base housing 162. Upon opening the lid 164, a floss loop is pulled upward and cut by the cutter 170 when the smaller tab 16 passes over the cutter. In this embodiment, the larger tab 14 is held in place at the opening, and as the lid closes, it grabs the larger tab 14, and pulls the floss loop 12 through the cutter 170. The cutter 170 is positioned to allow the small tab 16 through, and as the lid pivots backward further causes the cutter to engage the floss between the small tab 14 a6 and the next tab 16 of the next floss loop. Once engaged the cutter will cut the floss between the two tabs. When the lid 164 is closed, it is configured to grab the next waiting larger tab 14 for the next loop dispensing.

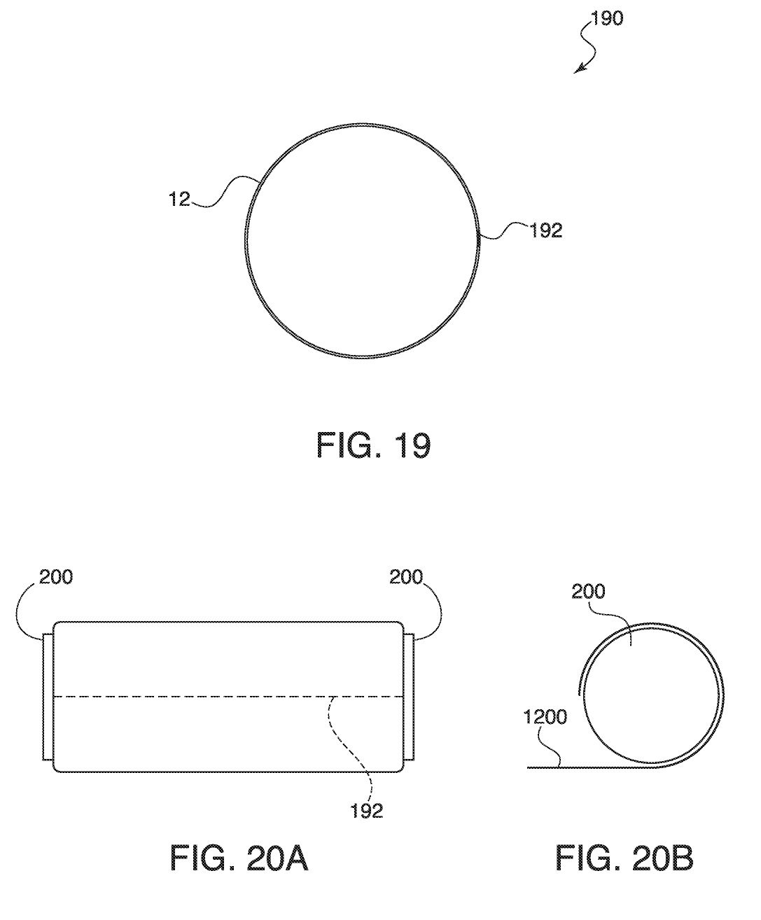

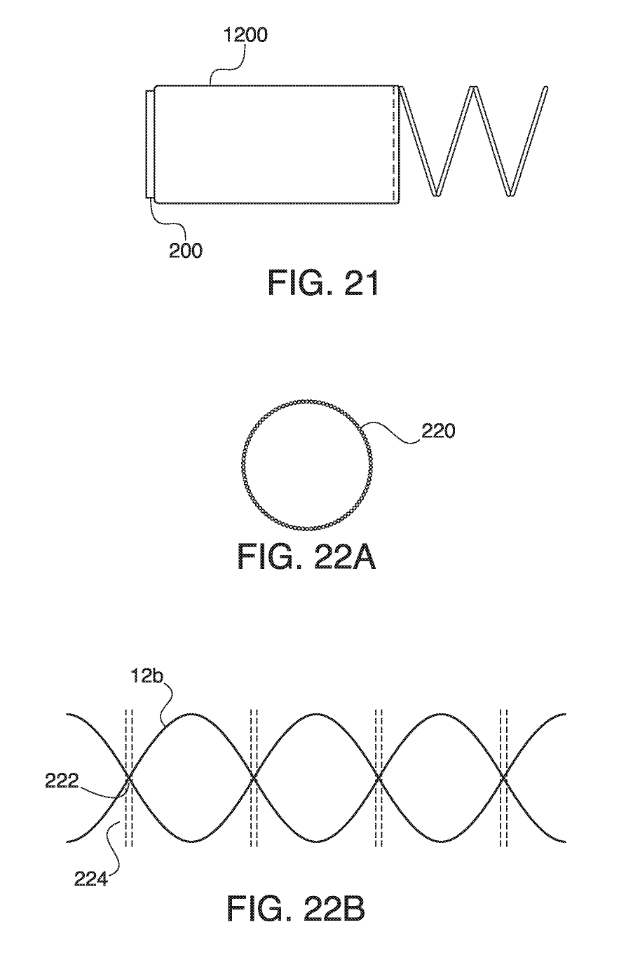

FIG. 19 is a plan view of a rolled loop 190 of floss 12 according to an embodiment of the present principles. A weld point 192 is generally formed by a heat weld. FIGS. 20A and 20B show the concept behind the rolled loop manufacturing. FIG. 20B shows a sheet of flat continuous floss material 1200 being wrapped around a cylinder 200 or the like. Once completely rolled thereon, a heat weld 192 is applied thereto. The floss loops are then stretched and removed from the cylinder and daisy chained together. (See FIG. 21)

FIG. 22A shows the embodiment of a wound loop 220 of dental floss. Here the fibers have been twisted on a looming machine to create a continuous loop. The termination point of the loop forms a small tag that becomes flush with the final loop.

FIG. 22B shows the manufacturing process behind creating a wound loop (see FIG. 22A). The floss fibers 12B are wound on a loom then formed into respective loops. At the intersection points 222 the loops are fused either with heat or glue. The connecting floss between the loops is then cut (dashed line 224) creating the final loops.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A dental floss comprising:
a first tab having opposing ends;
a piece of dental floss material having one end connected to one end of the first tab and a second end connected to an opposing end of the first tab thereby forming a continuous loop of dental floss material, said first tab providing a gripping location for the floss loop.

2. The dental floss of claim 1, further comprising a second tab positioned on the formed continuous loop substantially opposite said first tab.

3. The dental floss of claim 2, wherein the first and second tabs are different in size.

4. The dental floss of claim 2, wherein said first tab and said second tab operate to separate the continuous loop of dental floss material into two halves, the dental floss further comprising a plurality of strands of dental floss material connected to said first tab and said second tab along only one of said two halves.

5. The dental floss of claim 1, further comprising one or more knots in the piece of dental floss material.

6. The dental floss of claim 1, further comprising a pick device configured to receive and secure the first tab and continuous loop of dental floss material into the same, said pick device having a cutout area configured to provide a usable area of the dental floss material once inserted into the same.

7. The dental floss of claim 6, wherein the holder comprises:
a housing having at least one indentation configured to receive the first tab and the at least one cutout area; and
a circumferential channel disposed around said housing.

8. The dental floss of claim 7, wherein the pick device further comprises a tensioning mechanism configured to selectively increase tension of the dental floss material in the cutout portion.

9. A dental floss comprising:
a first tab;
a first strand of dental floss material having one end connected to the first tab and an opposing end;
a second tab connected to the opposing end of the first strand of dental floss material; and
a second strand of dental floss material having one end connected to the first tab and an opposing end connected to the second tab, said first and second strands of floss material connected to said first and second tabs forming the dental floss loop, said tabs providing a gripping feature to dental floss material.

10. The dental floss according to claim 9, wherein said second strand of dental floss material further comprises a plurality of additional strands of dental floss material. The dental floss according to claim 9, further comprising one or more knots in either the first strand or the second strand of floss material.

11. The dental floss according to claim 9, further comprising a pick device configured to receive and secure the first tab and the second tab forming continuous loop of dental floss material into the same, said pick device having a cutout area configured to provide a usable area of the dental floss material once inserted into the same.

12. The dental floss of claim 11, wherein the pick device comprises:
a housing having a first indentation configured to receive the first tab, a second indentation configured to receive the second tab, and the at least one cutout area; and
a circumferential channel disposed around said housing configured to receive the dental floss material.

13. The dental floss of claim 12, wherein the pick device further comprises a tensioning mechanism configured to selectively increase tension of the dental floss material in the cutout portion.
